(19) United States
(12) Patent Application Publication
(10) Pub. No.: US 2023/0360621 A1
(43) Pub. Date: Nov. 9, 2023

(54) AUTOMATIC PREPARATION OF A NEW MIDI FILE

(71) Applicant: Soundtrap AB, Stockholm (SE)

(72) Inventors: François PACHET, Paris (FR); Pierre ROY, Paris (FR)

(21) Appl. No.: 18/310,383

(22) Filed: May 1, 2023

Related U.S. Application Data
(63) Continuation of application No. 17/080,654, filed on Oct. 26, 2020, now Pat. No. 11,676,565.
(60) Provisional application No. 63/054,148, filed on Jul. 20, 2020.

(30) Foreign Application Priority Data
Nov. 21, 2019 (EP) 19210729

(51) Int. Cl. G10H 5/02

(52) U.S. Cl. CPC G10H 5/02

(57) ABSTRACT

The present disclosure relates to a method of automatically preparing a MIDI file based on a target MIDI file comprising respective note information about each of a plurality of target notes and a source MIDI file comprising respective note information about each of a plurality of source notes. Each note information comprises pitch information defining a pitch of the note. The method comprises ranking the plurality of target notes based on the pitch of each target note. The method also comprises, for each of the ranked target notes, removing the pitch information from the note information of the target note. The method also comprises, for each of the ranked target notes, replacing the removed pitch information with pitch information of a corresponding source note, whereby the target note has the same pitch as the corresponding source note, forming a plurality of new notes of a new MIDI file.

### RELATED APPLICATIONS

This application is a continuation of U.S. application Ser. No. 17/080,654, filed Oct. 26, 2020, which claims priority to U.S. Prov. App. No. 63/054,148, filed Jul. 20, 2020, and European App. No. EP19210729, filed Nov. 21, 2019, each of which is hereby incorporated by reference in its entirety.

### TECHNICAL FIELD

The present disclosure relates to automatically preparing a Musical Instrument Digital Interface (MIDI) file.

### BACKGROUND

A piano roll, e.g. of a MIDI file, contains notes, each of which is defined by:
Onset and duration (Time dimension).
Pitch (Frequency dimension).
Loudness/Velocity.
Optionally, timbre information, e.g., instrument name.

A rhythm is obtained by ignoring the pitch information.

### SUMMARY

It is an objective of the present invention to provide a new MIDI file based on a source MIDI file and a target MIDI file. In accordance with some embodiments of the present invention, the new MIDI file may be regarded as a re-harmonisation of the target MIDI file, using pitches based on the source MIDI file.

According to an aspect of the present invention, there is provided a method of automatically preparing a MIDI file based on a target MIDI file comprising respective note information about each of a plurality of target notes of the target MIDI file and a source MIDI file comprising respective note information about each of a plurality of source notes of the source MIDI file. Each note information, of both target and source notes, comprises pitch information defining a pitch of the note. The method comprises ranking the plurality of target notes based on the pitch of each target note. The method also comprises, for each of the ranked target notes, removing the pitch information from the note information of said ranked target note. The method also comprises, for each of the ranked target notes, replacing the removed pitch information with pitch information of a corresponding source note, whereby said target note has the same pitch as the corresponding source note (since the pitch information is now the same as for the corresponding source note), forming a plurality of new notes of a new MIDI file. Thus, each new note has a pitch of a corresponding source note.

According to another aspect of the present invention, there is provided a computer program product (e.g. a non-transitory computer readable storage medium) comprising computer-executable components for causing an electronic device to perform an embodiment of the method of the present disclosure when the computer-executable components are run on processing circuitry comprised in the electronic device.

According to another aspect of the present invention, there is provided an electronic device configured for performing an embodiment of the method of the present disclosure. Thus, the electronic device is configured for automatically preparing a MIDI file based on a target MIDI file comprising respective note information about each of a plurality of target notes of the target MIDI file and a source MIDI file comprising respective note information about each of a plurality of source notes of the source MIDI file. Each note information comprises pitch information defining a pitch of the note. The electronic device comprises processing circuitry, and data storage storing instructions executable by said processing circuitry whereby said electronic device is operative to rank the plurality of target notes based on the pitch of each target note; for each of the ranked target notes, remove the pitch information from the note information of the target note; and for each of the ranked target notes, replace the removed pitch information with pitch information of a corresponding source note, whereby the target note has the same pitch as the corresponding source note, forming a plurality of new notes of a new MIDI file.

By exchanging the pitch information of the target notes with pitch information of the source notes, the rhythm of the target MIDI file may be maintained while being re-harmonized with the source notes. Thus, a new MIDI file is automatically provided based on the source and target MIDI files. The new MIDI file may be outputted and played.

Embodiments of the method of the present disclosure may be regarded as a type of style or rhythm transfer. Style transfer has previously been proposed for images, e.g. “A Neural Algorithm for Artistic Style”, Gatys et al., using convolutional networks. Style Transfer has also been applied to symbolic music, using Generative Adversarial Networks (GANs), e.g. “Symbolic Music Genre Transfer with CycleGAN”, Brunner et al. However, the present invention is more specific in that harmony (pitches) and rhythm are transferred to a new note sequence of a new MIDI file. In practice, the results may be more musical (i.e. no wrong notes may be provided). Also, in some embodiments of the present invention, the invention works on single source and target MIDI files (no need for training on large datasets), and the result may be more predictable e.g. by a user. Also, parameters are natural, and may allow users to experiment with many meaningful combinations.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a schematic graph illustrating properties of a note, in accordance with an embodiment of the present invention.

FIG. 2 is a table illustrating properties of notes of a MIDI file, in accordance with an embodiment of the present invention.

FIG. 3 illustrates note information which may be stored in a MIDI file, in accordance with an embodiment of the present invention.

FIG. 4 illustrates how a new MIDI file can be formed by the rhythm of a target MIDI file in combination with pitches of a source MIDI file, in accordance with an embodiment of the present invention.

FIG. 5 is a table illustrating source and target lists of pitches, in accordance with an example embodiment of the present invention.

FIG. 6 is a table illustrating properties of notes of a new MIDI file automatically prepared based on the source and target lists of FIG. 5, in accordance with an example embodiment of the present invention.

FIG. 7 is a schematic flow chart of an embodiment of a method of the present invention.

FIG. 8 is a schematic block diagram of an embodiment of an electronic device in accordance with some embodiments of the present invention.

FIGS. 9A-9B is a schematic flow chart of an embodiment of a method of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

It is noted that when it is herein referred to MIDI files, it is often the audio (e.g. sequence of notes) encoded by the MIDI file which is intended. The length of a MIDI file, or a segment thereof, may thus be regarded as e.g. the number of bars or beats of the audio encoded thereby, or a time duration of the audio when played at a predetermined tempo.

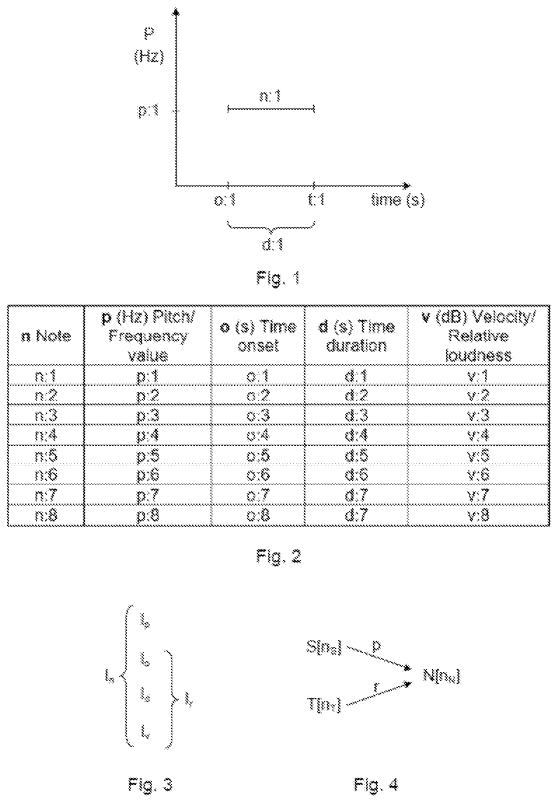

FIG. 1 illustrates properties of a note n of a MIDI file, here a first note n:1, in a two-dimensional graph with time on the x-axis and pitch (frequency) on the y-axis. In this two-dimensional system, the note n:1 may be defined with a pitch p:1, and its extension in time can be defined by any two of the properties onset o:1, termination t:1 and duration d:1. In addition, the note may be defined by velocity (i.e. relative loudness) v:1 (see FIG. 2) and, optionally, timbre (e.g. defined by type of instrument).

The table of FIG. 2 illustrates how each note n of a sequence of notes, here eight notes n:1-n:8, is defined by properties of pitch p, time onset o, time duration d and velocity v. Information I about these different properties may be stored in a MIDI file.

FIG. 3 illustrates that note information Iₙ of each note n, e.g. each of the notes n:1-n-8 of the sequence presented in FIG. 2, comprises pitch information Iₚ, onset information Iₒ, duration information I_{d} and velocity information L. As discussed above, the rhythm of a sequence of notes can be defined as the properties of the notes without the pitch p. Thus, rhythm information Iᵣ of a note corresponds to the note information Iₙ without the pitch information Iₚ, in this example corresponding to the onset information Iₒ, the duration information I_{d} and the velocity information L.

FIG. 4 illustrates how a new MIDI file N, having a sequence of new notes n_{N}, is formed from a combination of a target MIDI file T, having a sequence of target notes n_{T}, and a source MIDI file S, having a sequence of source notes n_{S}. In accordance with embodiments of the present invention, the new MIDI file N comprises the rhythm r from the target MIDI file T and the pitches p from the source MIDI file S.

In accordance with embodiments of the present invention, the new MIDI file N has the same (preferably exactly the same) rhythm r as the target MIDI file T. This implies that the sequence of notes n in the new MIDI file N may be the same as in the target MIDI file, and that the notes retain the same properties as in the target MIDI file T, e.g. onset o, duration d and velocity v, except for the pitch p. Optionally, additional property(ies), e.g. timbre, may be included in the rhythm r which is maintained between the new and target MIDI files. However, optionally, there may also be other property(ies) of the notes n, other than pitch p, which are not included in the maintained rhythm r.

In accordance with embodiments of the present invention, the pitches p of the new MIDI file N are based on the pitches of the source MIDI file S, they are preferably the same as the pitches of the notes of the source MIDI file, but typically not in the same order as in the note sequence of the source MIDI file. Thus, embodiments of the present invention may be regarded as including pitch substitution in the target MIDI file T by pitches of the source MIDI file S. The substitution may be done by mapping, which preferably finds a reasonable trade-off between the pitch distribution of the source and target MIDI files, which may be completely different, and the respective ranking (e.g. high to low or low to high) of the pitches of the source and target MIDI files, e.g. such that low pitches of the target MIDI file are substituted by low pitches of the source MIDI file and high pitches of the target MIDI file are substituted by high pitches of the source MIDI file. More generally, by means of embodiments of the present invention, harmonic (pitch) and rhythmic information from any two MIDI files (called source and target MIDI files herein) may be mixed to produce a new MIDI file N.

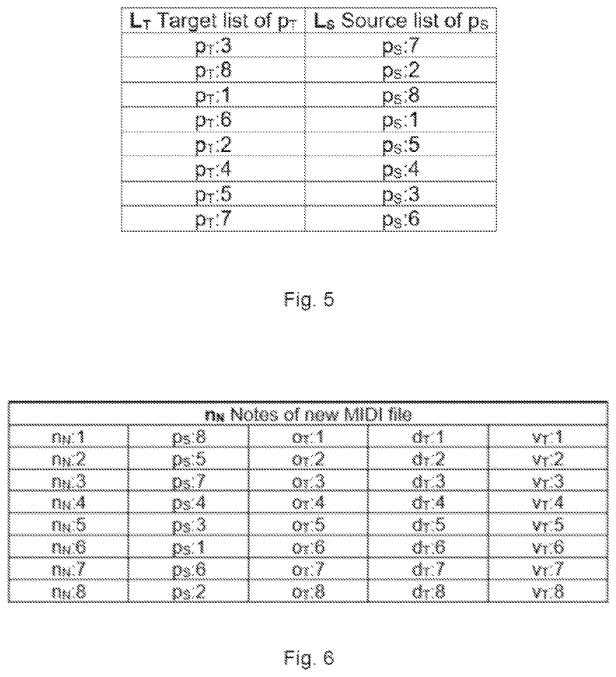

Different automated approaches may be used for achieving the pitch substitution. One approach, herein called the naïve method, may (with reference to FIGS. 5 and 6) include the following steps:
Ranking the target notes n_{T} by sorting the target notes, typically in ascending or descending order, based on the pitch p_{T} of each of the notes to form a target list L_{T}.
For each of the ranked target notes, removing the pitch information Iₚ from the note information Iₙ of the target note.
Sorting the source notes n_{S}, typically in ascending or descending order (same as for the sorting of the plurality of target notes n_{T}) based on the pitch p of each of the source notes to form a source list L_{S}. This may be done before, after or concurrently with the ranking of the target notes and/or the removing of pitch information from the target notes.
For each of the target notes in the target list L_{T}, replacing the removed pitch information Iₚ with the pitch information of the corresponding source note with the same rank in the source list L_{S}.

In the example of FIGS. 5 and 6, the target pitches p_{T}:1-p_{T}:8 of the sequence of target notes n_{T}:1-n_{T}:8 are ranked in ascending order in a target list L_{T}. Similarly, the source pitches p_{S}:1-p_{S}:8 of the sequence of source notes n_{S}:1-n_{S}:8 are ranked in ascending order in a source list L_{S}. Then, for each of the target notes, the pitch information Iₚ of the source note of the same rank in the lists L_{T} and L_{S} is included with the note information Iₙ of the target note. For example, in accordance with FIG. 5, the pitch information of the 7^{th} source note n_{S}:7 is added to the note information of the 3^{rd} target note n_{T}:3, etc. Thus, respective note information of new notes n_{N} of the new MIDI file N are formed, the first new note n_{N}:1 comprising the rhythm information Iᵣ from the first target note n_{T}:1 and the pitch information Iₚ from the 8^{th} source note n_{S}:8, etc.

Then, when the new notes n_{N} are reordered in the same order as the original sequence of the target notes n_{T} in the target MIDI file T, to form a sequence of new notes n_{N}:1-n_{N}:8, the properties of the new notes are as presented in the table of FIG. 6, and the new MIDI file is formed by the sequence of new notes n_{N}:1-n_{N}:8.

Additionally or alternatively, an approach using another algorithm, e.g. utilizing machine learning, may be used. With such an algorithm, the replacing of the removed pitch information with pitch information from source notes may comprise determining a probability distribution of the plurality of source notes based on the pitch of each of the source notes, and determining for each of the sorted target notes n_{T}, its corresponding source note n_{S} based on the determined probability distribution, wherein the determining of the probability distribution may be by means of a pre-trained model, e.g. comprising machine-learning such as neural networks.

In an example of a machine learning approach, the method may comprise the following steps:
Ranking the target notes (e.g. by time/pitch lexicographic order).
Removing the pitch information from the ordered target notes, thereby resulting in an ordered set of rhythmic placeholders.
Sequentially assigning new pitch information to each of the placeholders by selecting a pitch value from a set of pre-selected pitch values obtained from the source pitches of the source notes (e.g. all the pitches from a specific subset of the source notes), where the selection process may comprise or consist of:
   Computing a probability distribution over the set of pitches using a pre-trained model (e.g. using a neural network), which may e.g. take as input any of:
      The previous and current rhythmic placeholders.
      The pitch values already assigned to the previous rhythmic placeholders.
      The set of source pitches.
   Sampling from the probability distribution.

The pre-trained model may e.g. be trained in the following way:
Create a training set: for a plurality of (typically a large number of) target MIDI files,
   Rank the target notes in the target MIDI file (e.g. by time/pitch lexicographic order).
   Remove the pitch information from the ranked target notes, thereby resulting in an ordered set of rhythmic placeholders and a set of target pitches.
Train the model on the training set to perform the inference task described above, with its inputs being the (dissociated) rhythmic placeholders and the set of pitches from the same target notes, and where the ground truth data consists in the pitch information that was originally assigned to the respective target notes.

Generally, pitch (harmonic) information Iₚ from the source MIDI file S is mixed with rhythm information Jr from the target MIDI file T to automatically prepare the new MIDI file N.

In case the number of target notes is not the same as the number of source notes, notes can be added or removed from either the plurality of target notes or the plurality of source notes, such that the number of target notes is the same as the number of source notes. Removal of note(s) may be done randomly, or in any suitable non-random way. Added note(s) may e.g. be octave note(s) or any other note(s) e.g. which are more suitable for preserving the harmony of the source MIDI file. Generally, the replacing of the removed pitch information comprises: if the plurality of source notes n_{S} contains a higher number of notes than the plurality of target notes n_{T}, removing, e.g. randomly, at least one source note from the plurality of source notes or adding at least one note, e.g. octave note, to the plurality of target notes such that the plurality of source notes contains the same number of notes as the plurality of target notes; or, if the plurality of source notes n_{S} contains a lower number of notes than the plurality of target notes n_{T}, removing, e.g. randomly, at least one target note from the plurality of target notes or adding at least one note, e.g. octave note, to the plurality of source notes such that the plurality of source notes contains the same number of notes as the plurality of target notes.

In a more specific example, a pitch range, e.g. [m−8, M+8], is calculated, where m is the lowest pitch occurring among both the plurality of source and the plurality of target notes, respectively, and M is the maximum pitch occurring among both the plurality of source and the plurality of target notes, respectively. Then, a pitch p is determined for the plurality of source notes for which q=p+12 or q=p−12 such that m−8≤q≤M+8. If such a pitch p is found, q is added to the source pitches (e.g. of the source list L_{S}). If more pitches need to be added, the algorithm can be repeated. If no such pitch p is found, a random pitch may instead be removed from the target pitches (e.g. of the target list L_{T}), thus simplifying the rhythm r in case when the plurality of source notes contains fewer notes, and thus source pitches, than the plurality of target notes.

In some embodiments of the present invention, the plurality of source notes are the notes of a segment of the source MIDI file S, and the plurality of target notes are the notes of a segment of the target MIDI file T, from which segments a segment of the new MIDI file N is formed. Embodiments of the method of the present disclosure may then be performed for any pair of one source segment and one target segment, e.g. till all source notes and all target notes of the source and target MIDI files have been processed in accordance with the method (i.e. have been included at least once in the pluralities of target and source notes discussed herein). For example, the method may be applied to each successive segment of the source MIDI file in combination with respective each successive segment of the target MIDI file, such that e.g. segment i of the source MIDI file is combined with segment i of the target MIDI file, e.g. regardless of the number of target and source segments. If the number of notes per segment is different in any pair, notes may be added or removed as discussed herein.

In case the number of source segments is not the same as the number of target segments, the mapping of segments to each other may be stretched so that all of both source and target segments are used at least once. This ensures that all notes (i.e. the note information Iₙ thereof) in each file are processed with an embodiment of the method of the present disclosure. For instance, the shorter sequence of the notes (formed by the plurality of source or target notes) may be looped to form as many segments as the longer sequence.

A MIDI file (i.e. the sequence of notes n encoded thereby) may be segmented into only one segment (the whole file is then considered), or with regular segments of e.g. one beat, two beats, one bar, etc. The file can also be segmented with irregular segments.

A different segmentation can be used for each of the source and target MIDI files. For instance a source MIDI file in 3/4 can be segmented every three beats (1 bar), and if the target MIDI file is in 4/4 it can be segmented every four beats (also 1 bar). This may allow to use a rhythm/harmony in 4/4 and apply it to a 3/4 target.

Arbitrary combinations of segmenting schemes can be used, creating different results. A default segmenting scheme can be set (e.g. each two beats for both the source and the target MIDI files), but any other segmenting scheme may alternatively be used, e.g. by a musician who is experimenting.

When the method is applied to segments, then the successive results, i.e. the resulting sequence of new segments of the new MIDI file N, typically have to be concatenated to each other to produce a single new MIDI file.

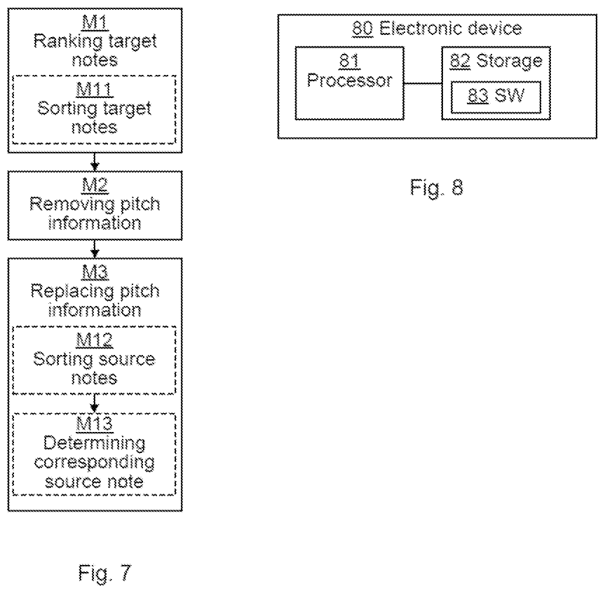

FIG. 7 illustrates some embodiments of the method of the present disclosure. The method is for automatically preparing a MIDI file based on a target MIDI file T comprising respective note information Iₙ about each of a plurality of target notes n_{T} of the target MIDI file and a source MIDI file S comprising respective note information Iₙ about each of a plurality of source notes n_{S} of the source MIDI file. Each note information (of both source and target notes) comprises pitch information Iₚ defining a pitch p of the note n_{T} or n_{S}.

The method comprises ranking M1 the plurality of target notes n_{T} based on the pitch p of each target note. In some embodiments, the ranking M1 comprises sorting M11 the plurality of target notes n_{T} based on the pitch p of each of the target notes to form a target list L_{T}.

The method also comprises, for each of the ranked M1 target notes n_{T}, removing M2 the pitch information Iₚ from the note information Iₙ of the target note. However, the rhythm information Iᵣ of the target note n_{T} typically remains part of the note information Iₙ of said target note.

The method also comprises, for each of the ranked M1 target notes n_{T}, replacing M3 the removed M2 pitch information with pitch information Iₚ of a corresponding source note n_{S}, whereby the target gets the same pitch p as the corresponding source note, forming a plurality of new notes n_{N} of a new MIDI file N. Thus, the note information Iₙ of each of the new notes n_{N} of the note sequence of the new MIDI file N typically comprises rhythm information Iᵣ from a target note n_{T} and pitch information Iₚ from a corresponding source note n_{S}.

In some embodiments, the replacing M3 comprises sorting M12 the plurality of source notes n_{S} based on the pitch p of each of the source notes to form a source list L_{S}, and for each of the sorted M11 target notes n_{T}, determining M13 its corresponding source note n_{S} as the source note having the same rank in the source list as the target note has in the target list. Thus, the source note which has the same rank in the source list L_{S}, e.g. any of the ranks 1^{st} to 8^{th} of FIG. 5, as a target note in the target list L_{T}, e.g. any of the ranks 1^{st} to 8^{th} of FIG. 5, is regarded as the source note which is corresponding to said target note.

In some embodiments, the replacing M3 comprises determining M21 a probability distribution of the plurality of source notes based on the pitch p of each of the source notes, and for each of the sorted target notes n_{T}, determining M22 its corresponding source note n_{S} based on the determined M21 probability distribution. In some embodiments, the determining M21 of the probability distribution is done by means of a pre-trained model, e.g. comprising machine-learning such as neural networks.

In some embodiments, typically independent on how the corresponding source notes are determined, the replacing M3 comprises: if the plurality of source notes n_{S} contains a higher number of notes than the plurality of target notes n_{T}, removing, e.g. randomly, at least one source note from the plurality of source notes or adding at least one note, e.g. octave note, to the plurality of target notes such that the plurality of source notes contains the same number of notes as the plurality of target notes; or if the plurality of source notes n_{S} contains a lower number of notes than the plurality of target notes n_{T}, removing, e.g. randomly, at least one target note from the plurality of target notes or adding at least one note, e.g. octave note, to the plurality of source notes such that the plurality of source notes contains the same number of notes as the plurality of target notes.

FIG. 8 schematically illustrates an embodiment of an electronic device 80 in accordance with some embodiments of the present invention. The electronic device 80 comprises processing circuitry 81 e.g. a central processing unit (CPU). The processing circuitry 81 may comprise one or a plurality of processing units in the form of microprocessor(s). However, other suitable devices with computing capabilities could be comprised in the processing circuitry 81, e.g. an application specific integrated circuit (ASIC), a field programmable gate array (FPGA) or a complex programmable logic device (CPLD). The processing circuitry 81 is configured to run one or several computer program(s) or software (SW) 83 stored in a data storage 82 of one or several storage unit(s) e.g. a memory. The storage unit 82 may be regarded as a computer readable means, forming a computer program product together with the SW 83 stored thereon as computer-executable components, as discussed herein and may e.g. be in the form of a Random Access Memory (RAM), a Flash memory or other solid state memory, or a hard disk, or be a combination thereof. The processing circuitry 81 may also be configured to store data in the storage 82, as needed.

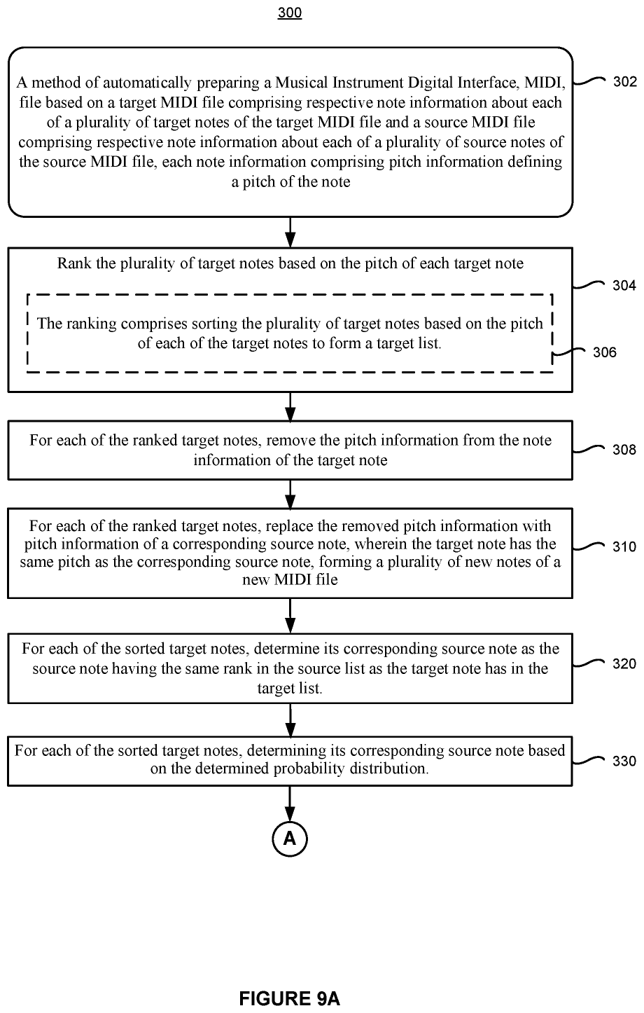

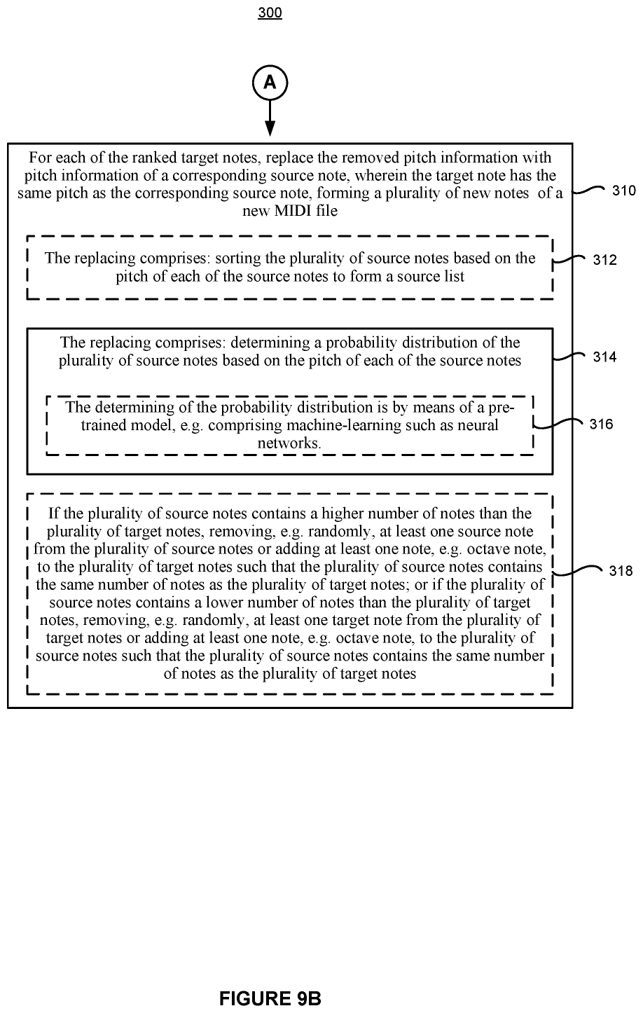

FIGS. 9A-9B illustrates flow charts of a method 300 for automatically preparing (302) a MIDI file based on a target MIDI file comprising respective note information about each of the target notes of the target MIDI file and a source MIDI file comprising respective note information about each of a plurality of source notes of the source MIDI file, each note information comprising pitch information defining a pitch of the note.

In some embodiments, the method 300 comprises block 304 which ranks the plurality of target notes based on the pitch of each target note. For example, the target notes may be ranked in ascending order from lowest pitch of each target note, to the highest pitch of each target note. Alternatively, the target notes may be ranked in descending order from highest pitch of each target note, to the lowest pitch of each target note. Alternatively, the pitch of each target note may be ranked according to a pre-selected or desired frequency, wherein the target notes are ranked according to which target notes have the closest frequency to the pre-selected or desired frequency.

In some embodiments, the method 300 further includes block 306 wherein the ranking comprising sorting the plurality of target notes based on the pitch of each target notes to form a target list. The list may be in ascending order, descending order, or in an order of proximity to the pre-selected or desired frequency.

In some embodiments, the method 300 further includes block 308 wherein for each of the ranked target notes, the pitch information is removed from the note information of the target note.

In some embodiments, the method further includes block 310 wherein for each of the ranked target notes, the removed pitch information is replaced with pitch information of a corresponding source note, wherein the target note has the same pitch as the corresponding source note, forming a plurality of new notes of a new MIDI file. In some embodiments, the corresponding source note has pitch information that is ranked. In some embodiments the pitch information of the source note is ranked in ascending order from lowest pitch of each source note, to the highest pitch of each source note. Alternatively, the source notes may be ranked in descending order from highest pitch of each source note, to the lowest pitch of each source note. Alternatively, the pitch of each source note may be ranked according to a pre-selected or desired frequency, wherein the source notes are ranked according to which source notes have the closest frequency to the pre-selected or desired frequency.

In some embodiments, block 320 is included wherein for each of the sorted target notes, the corresponding source note is determined as the source note having the same rank in the source list as the target note has in the target list. For example, once the source notes have been ranked, the ranked pitch information corresponding to the target note, and the ranked pitch information corresponding to the source note are matched based on the target list. In some embodiments, the highest pitch of the target note and the highest pitch of the source note are matched and the lowest pitch of the target note are matched. The pitch of the target note is then replaced with the matched pitch of the source note.

In some embodiments, the method further includes block 330 wherein for each of the sorted target notes, its corresponding source note is determined based on the determined probability distribution.

FIG. 9B illustrates further embodiments of block 310. In some embodiments, block 310 further comprises block 312 wherein the replacing comprises sorting the plurality of source notes based on the pitch of each of the source notes to form a source list.

In some embodiments, block 310 includes block 314 wherein the replacing comprises determining a probability distribution of the plurality of source notes based on the pitch of each of the source notes.

In some embodiments, block 314 further comprises block 316 wherein the determining of the probability distribution is by means of a pre-trained model. For example, the pre-trained model uses machine learning such as neural networks. In some embodiments, the pre-trained model will select and replace the correct target notes with the source notes depending on a pre-defined or desired pitch. For example, a deep neural network (DNN) is trained to predict the pitches of all the notes in a MIDI file with degraded pitch information. This is done by inputting the MIDI files from which the pitch information is degraded. The DNN predicts a probability vector of dimension for each note with degraded pitch information (e.g., one vector for each MIDI pitch in the MIDI format). The error is then measured by adding the distance between the predicted probability vector and a one hot vector with 1 for the actual pitch of the note for each note (i.e., the pitch in the original MIDI file). The distance may be any vector distance (e.g., root-mean squared).

In some embodiments, the pre-trained model is trained on short fragments (e.g., ranging from 1 beat to 2 measures). In some embodiments, the degradation of the pitch information may follow several strategies. In some embodiments, the first strategy (Strategy 1) is to remove the pitch information (e.g., each note being represented by its start time, its end time, its velocity, and a vector of dimension 128 with 0 everywhere). In some embodiments, the second strategy (Strategy 2) is the replacement of the pitch information by a ranking information (e.g., the lowest pitch is replaced by value 0, the second lowest by value 1, and so on). In some embodiments, the third strategy (Strategy 3) is to “blur” the pitch information (e.g., The actual pitch is 0 <p <127, this is replaced by a vector of dimension 128 with 0 everywhere except “near” p, e.g., the vector has 1 at indices p−5, . . . , p, . . . , p+5.

In some embodiments, the trained DNN is used to perform rhythm-harmony transfer between MIDI files. For example, given two MIDI fragments H and R of lengths similar to that used to train the DNN, an input T is created for the DNN by removing the pitch information from R following one of Strategy 1, Strategy 2, or Strategy 3. For each note with degraded pitch information in T, the DNN predicts a probability vector of dimension 128.

In some embodiments, block 310 further comprises block 318 wherein the replacing comprises if the plurality of source notes contains a higher number of notes than the plurality of target notes, removing, e.g. randomly, at least one source note from the plurality of source notes or adding at least one note, e.g. octave note, to the plurality of target notes such that the plurality of source notes contains the same number of notes as the plurality of target notes; or if the plurality of source notes contains a lower number of notes than the plurality of target notes, removing, e.g. randomly, at least one target note from the plurality of target notes or adding at least one note, e.g. octave note, to the plurality of source notes such that the plurality of source notes contains the same number of notes as the plurality of target notes. In some embodiments, the removal of the note is the lowest ranked note, or the highest ranked note. In another embodiment, the removal of the note is the farthest in proximity from a desired note.

Note that, in some embodiments, method 300 is performed for a plurality of portions of the source and target files. For example, method 300 is performed for temporally-aligned portions of the composition, such as beats or frames. Thus, the harmony for each frame of the target file is replaced by the harmony for a corresponding frame of the source file.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art. In some embodiments, the present invention includes a computer program product 82 which is a non-transitory storage medium or computer readable medium (media) having instructions 83 stored thereon/in, in the form of computer-executable components or software (SW), which can be used to program a computer to perform any of the methods/processes of the present invention.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. (canceled)

2. A method of automatically preparing a Musical Instrument Digital Interface, MIDI, file based on a target MIDI file comprising respective note information about each of a plurality of target notes of a target segment of the target MIDI file and a source MIDI file comprising respective note information about each of a plurality of source notes of a source segment of the source MIDI file, each note information comprising pitch information defining a pitch of the note, the method comprising:
for each of a plurality of segment pairs that include a respective target segment and a respective source segment:
ranking the plurality of target notes based on the pitch of each target note;
forming a plurality of new notes of a new segment by, for each of the ranked target notes:
removing the pitch information from the note information of the target note; and
replacing the removed pitch information with pitch information of a corresponding source note, whereby the new note corresponding to the respective target note has the same pitch as the corresponding source note; and
concatenating the new segment with one or more other new segments to form a new MIDI file.

3. The method of claim 2, wherein the plurality of segment pairs comprises a plurality of target segments including all the target notes of the target MIDI file and/or a plurality of source segments including all the source notes of the source MIDI file.

4. The method of claim 3, wherein the plurality of segment pairs consists of the plurality of target segments and the plurality of source segments, wherein the plurality of target segments includes each of the target notes only once and/or the plurality of source segments includes each of the source notes only once.

5. The method of claim 3, wherein the method is performed on all of the plurality of target segments and all of the plurality of source segments at least once.

6. The method of claim 2, wherein the method is performed on each successive source segment paired with respective each successive target segment.

7. The method of claim 2, wherein the target MIDI file is segmented to form the target segments, and/or the source MIDI file is segmented to form the source segments, as regular segments.

8. The method of claim 7, wherein the regular segments comprise segments of one beat, two beats or one bar.

9. The method of claim 2, further comprising:
if the plurality of source notes contains a higher number of notes than the plurality of target notes, removing at least one source note from the plurality of source notes or adding at least one note to the plurality of target notes such that the plurality of source notes contains the same number of notes as the plurality of target notes; and
if the plurality of source notes contains a lower number of notes than the plurality of target notes, removing at least one target note from the plurality of target notes or adding at least one note to the plurality of source notes such that the plurality of source notes contains the same number of notes as the plurality of target notes.

10. The method of claim 2, wherein the note information comprises pitch information defining a pitch of the respective target note and information for one or more non-pitch properties for the respective target note.

11. The method of claim 10, wherein the one or more non-pitch properties for the respective target note include an onset of the respective note.

12. The method of claim 10, wherein the one or more non-pitch properties for the respective target note include a duration of the respective note.

13. The method of claim 10, wherein the one or more non-pitch properties for the respective target note include a velocity of the respective note.

14. The method of claim 10, wherein the one or more non-pitch properties for the respective target note include a timbre of the respective note.

15. A computer system, comprising:
one or more processors; and
memory storing one or more programs for execution by the one or more processors, the one or more programs including instructions for automatically preparing a Musical Instrument Digital Interface, MIDI, file based on a target MIDI file comprising respective note information about each of a plurality of target notes of a target segment of the target MIDI file and a source MIDI file comprising respective note information about each of a plurality of source notes of a source segment of the source MIDI file, each note information comprising pitch information defining a pitch of the note, including instructions for:
for each of a plurality of segment pairs that include a respective target segment and a respective source segment:
ranking the plurality of target notes based on the pitch of each target note;
forming a plurality of new notes of a new segment by, for each of the ranked target notes:
removing the pitch information from the note information of the target note; and
replacing the removed pitch information with pitch information of a corresponding source note, whereby the new note corresponding to the respective target note has the same pitch as the corresponding source note; and
concatenating the new segment with one or more other new segments to form a new MIDI file.

16. The computer system of claim 15, wherein the plurality of segment pairs comprises a plurality of target segments including all the target notes of the target MIDI file and/or a plurality of source segments including all the source notes of the source MIDI file.

17. The computer system of claim 15, wherein the plurality of segment pairs consists of the plurality of target segments and the plurality of source segments, wherein the plurality of target segments includes each of the target notes only once and/or the plurality of source segments includes each of the source notes only once.

18. The computer system of claim 15, wherein the target MIDI file is segmented to form the target segments, and/or the source MIDI file is segmented to form the source segments, as regular segments.

19. The computer system of claim 18, wherein the regular segments comprise segments of one beat, two beats or one bar.

20. The computer system of claim 15, the one or more programs further including instructions for:
if the plurality of source notes contains a higher number of notes than the plurality of target notes, removing at least one source note from the plurality of source notes or adding at least one note to the plurality of target notes such that the plurality of source notes contains the same number of notes as the plurality of target notes; and
if the plurality of source notes contains a lower number of notes than the plurality of target notes, removing at least one target note from the plurality of target notes or adding at least one note to the plurality of source notes such that the plurality of source notes contains the same number of notes as the plurality of target notes.

21. A non-transitory computer readable storage medium storing one or more programs for execution by one or more processors, the one or more programs including instructions for automatically preparing a Musical Instrument Digital Interface, MIDI, file based on a target MIDI file comprising respective note information about each of a plurality of target notes of a target segment of the target MIDI file and a source MIDI file comprising respective note information about each of a plurality of source notes of a source segment of the source MIDI file, each note information comprising pitch information defining a pitch of the note, including instructions for:
for each of a plurality of segment pairs that include a respective target segment and a respective source segment:
ranking the plurality of target notes based on the pitch of each target note;
forming a plurality of new notes of a new segment by, for each of the ranked target notes:
removing the pitch information from the note information of the target note; and
replacing the removed pitch information with pitch information of a corresponding source note, whereby the new note corresponding to the respective target note has the same pitch as the corresponding source note; and
concatenating the new segment with one or more other new segments to form a new MIDI file.
